(19) United States
(12) Patent Application Publication
(10) Pub. No.: US 2009/0058221 A1
(43) Pub. Date: Mar. 5, 2009

(54) SYSTEM AND METHOD FOR PROTECTING SUBMERSIBLE MOTOR WINDING

(75) Inventor: Joseph C. Liu, Ramona, OK (US)

Correspondence Address: SCHLUMBERGER RESERVOIR COMPLETIONS, 14910 AIRLINE ROAD, ROSHARON, TX, 77583, US

(73) Assignee: Schlumberger Technology Corporation, Sugar Land, TX (US)

(21) Appl. No.: 11/846,775

(22) Filed: Aug. 29, 2007

(51) Int. Cl. H02K 5/132; E21B 4/04; F04D 13/08; F04D 13/10

(52) U.S. Cl. 310/260; 310/87; 166/66.4; 417/423.3

(57) ABSTRACT

A technique is provided for constructing a submersible motor. The submersible motor has a stator positioned within a housing. Windings are arranged through the stator with end coils on opposite ends of the stator. The winding end coils are supported by a support structure that prevents the end coils from collapsing inwardly.

### BACKGROUND

Submersible motors are used in a wide variety of well related applications. For example, submersible motors are utilized in electric submersible pumping systems employed to produce fluids, such as hydrocarbon based fluids. The electric submersible pumping systems also can be used to deliver fluid downhole or to transfer fluid to other locations. The submersible motor generally is a long cylindrical motor sized to fit within a wellbore and designed to drive a centrifugal pump.

Because submersible motors operate in a submerged environment, conventional submersible motor stators have been insulated with a varnish material. However, with recent modifications made to the magnet wire, and impregnating the stator and windings with varnish is a relatively expensive procedure. Additionally, the varnish can degrade over time and cause a variety of problems, including contamination of the motor oil and cause bearing failures. The varnish also can limit certain operational parameters of the submersible motor. As a result, attempts have been made to construct submersible motors without varnish. Other insulating materials, including epoxies, have been used to cover the windings and end coils associated with the stator of the submersible motor. However, these approaches have proved inadequate in providing support for the winding end coils to prevent them from collapsing into the stator bore, particularly with larger submersible motors.

### SUMMARY

In general, the present invention provides a system and method for constructing a submersible motor. A stator is positioned within a housing, and stator windings are arranged with an end coil on an end of the stator. The winding end coil is supported by a support structure that prevents the end coil from collapsing inwardly and causing failure.

### BRIEF DESCRIPTION OF THE DRAWINGS

Certain embodiments of the invention will hereafter be described with reference to the accompanying drawings, wherein like reference numerals denote like elements, and:

FIG. 1 is a front elevation view of a well system having a submersible motor in a wellbore, according to an embodiment of the present invention;

FIG. 2 is a partial cross-section of the submersible motor illustrated in the well system of FIG. 1, according to an embodiment of the present invention;

FIG. 3 is a front view of one embodiment of a support structure for use in the submersible motor, according to an embodiment of the present invention; and

FIG. 4 is a top view of the support structure illustrated in FIG. 3, according to an embodiment of the present invention.

### DETAILED DESCRIPTION

In the following description, numerous details are set forth to provide an understanding of the present invention. However, it will be understood by those of ordinary skill in the art that the present invention may be practiced without these details and that numerous variations or modifications from the described embodiments may be possible.

The present invention generally relates to a well system that utilizes a submersible motor. For example, a submersible motor may be used in an electric submersible pumping system to produce or otherwise move desired well fluids. The technique improves the run life of submersible motors and facilitates the use of both larger motors and motors constructed without varnish to isolate the stator and windings of the motor. In some applications, for example, motors are constructed without varnish to reduce cycle time and cost. However, removing the varnish also removes some of the support for the winding end coils.

In the present system and methodology, the end coils of the stator windings are supported by an insert. The insert prevents the winding end coils from moving and collapsing into the stator bore due to its own weight, thus avoiding failure or detrimental operation of the submersible motor. By way of specific example, the insert may comprise a conical structure positioned on the radially inward side of the end coils to prevent detrimental movement and collapse of the end coils in a radially inward direction toward the stator bore.

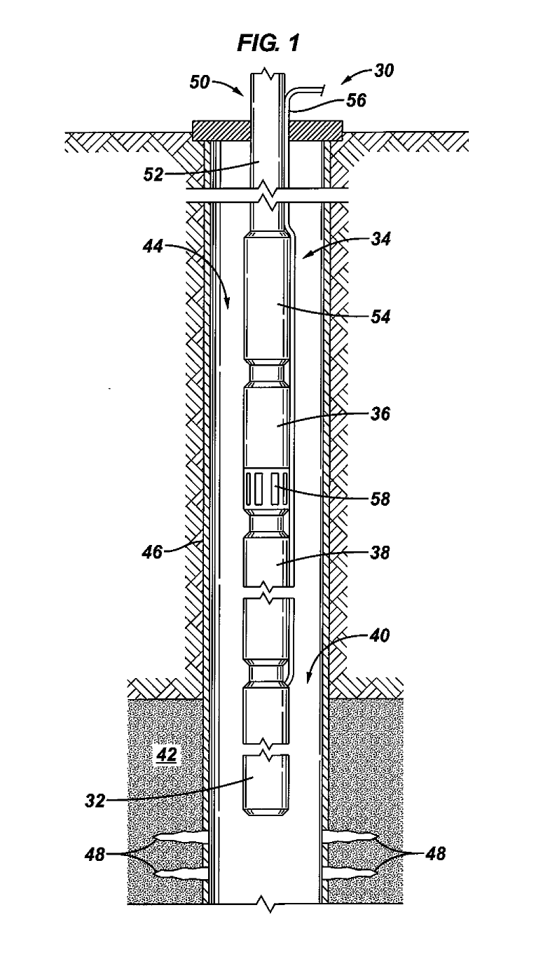

Referring generally to FIG. 1, one example of a well system 30 utilizing a submersible motor 32 is illustrated according to an embodiment of the present invention. In this embodiment, well system 30 comprises an electric submersible pumping system 34. The electric submersible pumping system 34 may comprise a variety of components depending on the particular application or environment in which it is used. In many applications, electric submersible pumping system 34 comprises at least a submersible pump 36, submersible motor 32, and a motor protector 38 positioned between submersible pump 36 and submersible motor 32.

In the embodiment illustrated, electric submersible pumping system 34 is designed for deployment in a well 40 within a geological formation 42 containing desirable production fluids, such as hydrocarbon based fluids. A wellbore 44 typically is drilled into formation 42 and, at least in some applications, is lined with a wellbore casing 46. The wellbore casing 46 is perforated to form a plurality of openings (perforations) 48 through which production fluids can flow from formation 42 into wellbore 44. In other applications, the submersible pumping system 34 can be used to deliver treatment fluids downhole and out through perforations 48 into the surrounding reservoir.

The electric submersible pumping system 34 may be deployed into wellbore 44 with a suitable conveyance system 50 that can be constructed in a variety of forms and configurations depending on the application. For example, conveyance system 50 may comprise a tubing 52, such as production tubing or coiled tubing. The conveyance system 50 is connected to submersible pump 36 or to another appropriate component of electric submersible pumping system 34 by a connector 54. In the embodiment illustrated, a power cable 56 is routed downhole along conveyance system 50 and electric submersible pumping system 34 to submersible motor 32. The power cable 56 provides electrical power to submersible motor 32 so the submersible motor can, in turn, power submersible pump 36. In operation, submersible pump 36 draws well fluid into the electric submersible pumping system 34 via a pump intake 58 and pumps the fluid to a collection location through, for example, tubing 52. By way of example, submersible motor 32 may comprise a three-phase, induction motor in which stator windings provide the motor field. The submersible motor may be constructed with/without varnish, and the stator windings have end coils that are uniquely supported with a support structure, as described in greater detail below.

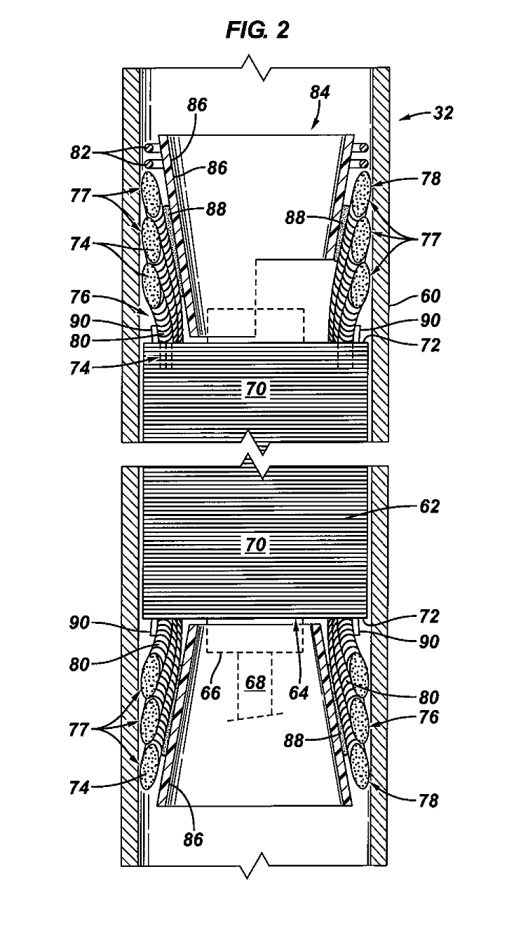

Referring generally to FIG. 2, one embodiment of submersible motor 32 is illustrated. In this embodiment, submersible motor 32 comprises an outer housing 60, such as a tubular housing. A stator 62, having a stator bore 64, is positioned within the housing 60 such that the stator bore 64 is generally aligned with housing 60 in an axial direction. As illustrated by dashed lines, a rotor 66 is rotatably positioned within stator bore 64 and coupled to a drive shaft 68. During operation, the rotating rotor 66 causes drive shaft 68 to rotate, and this rotation is used to drive submersible pump 36.

By way of example, stator 62 is formed with a plurality of laminations 70, such as steel laminations. The stack of steel laminations may be insulated by suitable insulating laminations 72 disposed at opposed axial ends of the lamination stack. In many applications, the laminations are perforated in a manner that creates generally axial slots to receive insulated wire conductors 74 that form the motor windings 76. At axial ends of the lamination stack, the insulated wire conductors 74 of the windings 76 are looped into end turns 77 that form winding end coils 78. The end turns 77 enable the insulated wire conductors 74 to be directed back through the lamination stack via axial slots according to a desired winding pattern. The insulated wire conductors 74 that form end coils 78 can be grouped together with each group secured by a suitable wrap 80 or other type of covering. Electrical power can be supplied to winding 76 via appropriate lead wires 82. If submersible motor 32 is a three-phase motor, the end coils 78 comprise end turns 77 for all three phases.

The end coils 78 are supported by a support structure 84 that limits or prevents radial collapse of the end coils by preventing undesirable movement of the end turns 77. Generally support structure 84 comprises an insert 86, and typically a pair of inserts 86, that are inserted at a radially inward position relative to the end coils 78, as illustrated in FIG. 2. The inserts 86 prevent the end coils 78 from collapsing toward stator bore 64 which otherwise could result in motor damage or failure of the motor. The support structure 84 also is designed to accommodate the insertion of rotor 66 and a drive shaft 68 while protecting the end turns 77 from being damaged by the rotor 66 and drive shaft 68 during assembly and disassembly of submersible motor 32.

In the embodiment illustrated, inserts 86 are preformed inserts constructed from a stiff, high temperature, insulation material. The inserts 86 may be secured in position by an appropriate adhesive material 88, such as glue or epoxy. The end coils 78 also can be infused or covered with the adhesive material 88, e.g. glue or epoxy, to further enhance the mechanical stability of the end coils. In some applications, the end coils 78 can be further supported by appropriate structures, such as coil forming blocks or wedges 90.

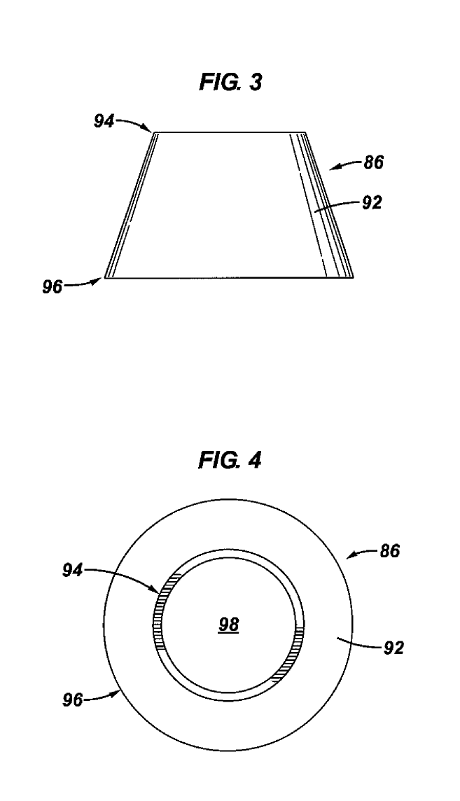

With added reference to FIGS. 3 and 4, one embodiment of support structure 84 utilizes inserts 86 that are conical structures 92 sized to fit within the end coils 78 at each end of stator 62. As illustrated in the front view of FIG. 3 and the top view of FIG. 4, each conical structure 92 comprises smaller end 94 of reduced diameter relative to a larger end 96. The smaller diameter end 94 is positioned adjacent the stack of laminations 70 such that the conical structure increases in diameter at increasing distances from the lamination stack. An opening 98 extends axially through the conical structure 92 and increases in diameter moving from smaller diameter end 94 to larger diameter end 96. This conical structure maintains end coils 78 at a position that does not interfere with the stator bore 64 while enabling easy insertion and removal of rotor 66.

The shape, size, material and configuration of support structure 84 and inserts 86 can be adjusted according to the environment and the type/size of submersible motor 32. If a conical structure 92 is utilized, the diameter and length of the conical structure can vary from one application to another or even within the same submersible motor 32. In FIG. 2, for example, the upper insert 86 is illustrated as a cone that can either have a long sidewall, as illustrated on the left, or a short sidewall, as illustrated on the right. Numerous other adaptations of the preformed insert can be made as required for a given submersible motor design or application.

The embodiments described above provide examples of submersible motors and support structures that can be used to improve the run life of a variety of well systems. It should be noted, however, that the support structures can be used to prevent the radially inward collapse of end coils in many types of motors and in a wide variety of well related applications. Additionally, the material used to create the support structure, the number of support structure components used in an individual motor, and the configuration of those components can be adjusted as needed for a given application. Though multiple end coils 78 are noted most often, one or more end coils are contemplated. Also, though end coils 78 and associated parts and description and most often contemplated with respect to both ends of a motor/stator device, it is contemplated that separate features are equally applicable to only one end thereof.

Accordingly, although only a few embodiments of the present invention have been described in detail above, those of ordinary skill in the art will readily appreciate that many modifications are possible without materially departing from the teachings of this invention. Such modifications are intended to be included within the scope of this invention as defined in the claims.

What is claimed is:

1. A device for use in a wellbore, comprising:
an electric submersible pumping system motor comprising:
a tubular housing;
a stator deployed within the tubular housing;
stator winding magnetic wire having an end coil; and
a conical structure inserted adjacent to the end coil to support the end coil in a manner that prevents the end coil from collapsing into a stator bore region.

2. The device as recited in claim 1, wherein the electric submersible pumping system motor is constructed with varnish surrounding the winding magnet wire.

3. The device as recited in claim 1, wherein the end coil comprises a plurality of insulated wire conductors that form end turns.

4. The device as recited in claim 3, wherein the electric submersible pumping system motor is a three-phase motor and the end coil comprises end turns for all three phases.

5. The device as recited in claim 3, wherein glue is applied to the end coil to provide added structural stability.

6. The device as recited in claim 1, wherein the conical structure is glued into a desired position.

7. The device as recited in claim 1, wherein the conical structure comprises an insulating material.

8. The device as recited in claim 1, wherein the stator winding comprises a pair of end coils, and the conical structure comprises a pair of conical structures with one conical structure inserted into each end coil.

9. A method, comprising:
constructing a motor with a housing sized for deployment in a wellbore;
positioning a stator within the housing such that a stator bore is axially aligned with the housing;
providing the stator with stator windings having an end coil; and
supporting the end coil with a preformed structure that prevents the end coil from collapsing toward the stator bore.

10. The method as recited in claim 9, wherein supporting comprises supporting the end coil with a conical preformed structure.

11. The method as recited in claim 9, further comprising gluing the preformed structure to the end coil.

12. The method as recited in claim 9, further comprising mounting the motor in an electric submersible pumping system and deploying the electric submersible pumping system into a wellbore.

13. The method as recited in claim 9, further comprising inserting a rotor into the stator bore after supporting the end coil with the preformed structure.

14. A system for use in producing fluid from a wellbore, comprising:
a submersible pump;
a motor protector; and
a submersible motor to power the submersible pump through the motor protector, the submersible motor having windings with an end coil, the end coil being supported by a support structure inserted into the end coil to prevent a radially inward collapse of the end coil.

15. The system as recited in claim 14, wherein the support structure comprises a preformed conical structure.

16. The system as recited in claim 15, wherein the preformed conical structure is adhered within the end coil.

17. The system as recited in claim 16, wherein the end coil comprises a plurality of end turns.

18. The system as recited in claim 15, wherein the preformed conical structure is formed from an insulating material.

19. A method, comprising:
constructing a submersible motor with stator windings having an end coil; and
supporting the end coil against radially inward collapse with an insert deployed radially inward of the end coil.

20. The method as recited in claim 19, wherein constructing comprises constructing the submersible motor with varnish.

21. The method as recited in claim 19, further comprising combining the submersible motor with a submersible pump and a motor protector to form an electric submersible pumping system.

22. The method as recited in claim 19, wherein supporting comprises adhering the insert in position within the end coil.

23. The method as recited in claim 19, wherein supporting comprises supporting the end coil with the insert, wherein the insert is conical.

24. The method as recited in claim 23, further comprising supporting a second end coil with a second insert, wherein the insert is conical.

25. The device of claim 1, wherein the electric submersible pumping system motor is constructed with epoxy surrounding the winding magnet wire
